(19) United States
(12) Patent Application Publication
(10) Pub. No.: US 2009/0327958 A1
(43) Pub. Date: Dec. 31, 2009

(54) ELECTRONIC DEVICE HAVING MULTIPLE OPERATION MODES AND A METHOD OF PROVIDING THE MULTIPLE OPERATION MODES

(75) Inventor: HSING-YU LUNG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/417,654

(22) Filed: Apr. 3, 2009

(30) Foreign Application Priority Data
Jun. 27, 2008 (CN) 200810302385.1

(51) Int. Cl. G06F 3/048

(52) U.S. Cl. 715/810

(57) ABSTRACT

An electronic device providing multiple operation modes is provided. The electronic device has a user interface displayed via a display device connected to the electronic device. The user interface displays icons corresponding to the multiple operation modes, receives a selection signal corresponding to a user-selected operation mode from an input device, and provides and displays corresponding function options to the user interface under the user-selected operation mode.

### BACKGROUND

1. Technical Field

Embodiments of the present disclosure are related to device controlling systems and methods, and particularly to an electronic device having multiple operation modes and a method of providing the multiple operation modes in the electronic device.

2. Description of Related Art

Presently, electronic devices, such as personal digital assistants, mobile phones, or personal computers (PC), only provide a single operation mode to users. That is, all function icons are displayed on a menu of an electronic device. In addition, when a user selects one function icon, all function options corresponding to the selected function icon will be displayed to the user, then the user needs to look through each of the function options to select a desired function option.

However, the above mention mode may be confusing for users of a complicated electronic device having many functions. The complicated electronic device may present many functions for the users who may only need a few simple functions, which can cause confusion and waste time for the user searching for the desired function. However, if the electronic device provides too few functions, the users who need advanced functions may feel disappointed about the electronic device.

### BRIEF DESCRIPTION OF THE DRAWINGS

FIG. 1 is a block diagram of one embodiment of an electronic device having multiple operation modes.

FIG. 2 is a block diagram of one embodiment illustrating function options corresponding to the same function menu under different operation modes of the electronic device of FIG. 1.

FIG. 3 is a flowchart of one embodiment of a method of providing multiple operation modes in the electronic device.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

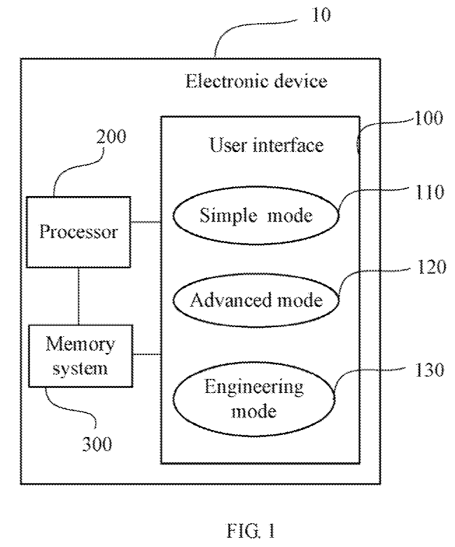

FIG. 1 is a block diagram of one embodiment of an electronic device 10. In one embodiment, the electronic device 10 includes a user interface 100 displayed via a display device (not shown) of the electronic device 10, a processor 200, and a memory system 300. Depending on the embodiment, the electronic device 10 may be a mobile phone, a vehicle terminal, or any other appropriate device.

The user interface 100 provides multiple operation modes icons. For example, icons of a simple mode 110, an advanced mode 120, and an engineering mode 130, are displayed for users to select one operation mode and use corresponding functions under the selected operation mode. Available function options provided by different operation modes may be different. For example, simple and commonly used function options are listed under the simple mode 110. Under the advanced mode 120, advanced function options are also listed. Under the engineering mode 130, more professional function options that may be needed by some professional users, such as software research and development people, are listed with the options of the other two modes.

The memory system 300 stores codes of the multiple operation modes and other software applications, such as an operating system of the electronic device 1. In one embodiment, the memory system 300 may be an external storage card, e.g., a smart media card, a secure digital card, a compact flash card, or any other type of memory card. The processor 200 executes the codes of the multiple operation modes and other software applications, to provide functions of the electronic device 10.

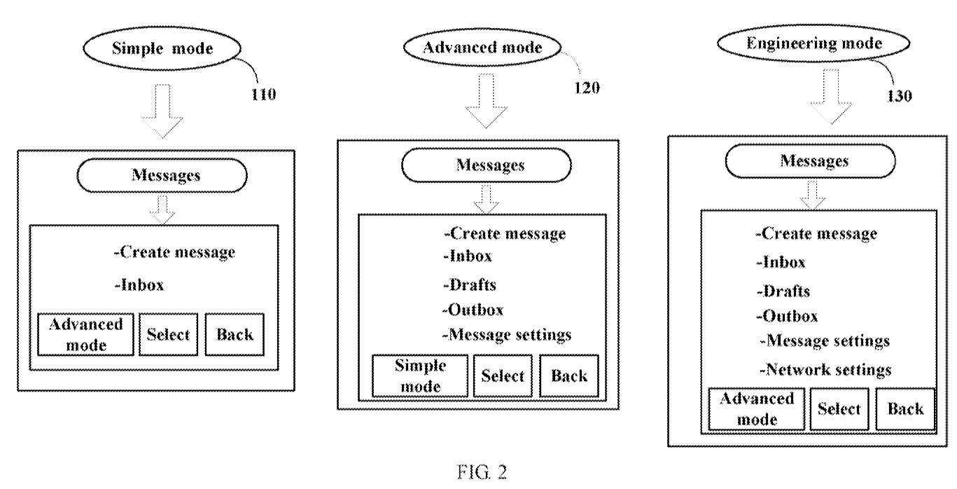

FIG. 2 is a block diagram of one embodiment of an interface illustrating function options corresponding to the same function menu “Messages” under different operation modes of the electronic device 10. Under the simple mode 110, available options of the function menu “Messages” may only include “Create message” and “Inbox,” which can satisfy the lowest demands of particular users, e.g., young kids or the elderly. Under the advanced mode 120, available options of the function menu “Messages” may further include “Drafts,” “Outbox” and “Message settings” besides the above mentioned options under the simple mode 110, so as to provide more functions such as setting message templates via the “Message settings” option. Under the engineering mode 130, the function menu “Messages” further provides some options that might only be used by electronic engineers during research and development of the electronic device 10, such as an option of “Network settings” for setting and testing networks for receiving and sending messages. The networks may include general packet radio service (GPRS) network, global system for mobile communications (GSM) network, or any other type of networks.

In addition to providing function options, each operation mode also provides icons of the other operation modes, for users to change from one operation mode to another. For example, under the simple mode 110, the user interface 100 provides the icon to enter into the advanced mode 120 that users can select to directly enter the advance mode 120. Under any operation mode, the user interface 100 also provides other operation icons, such as “Select” and “Back” for the users to select one function option or return to last directory.

Other function menus, such as “PhoneBook,” “Setting,” “My Favorites,” “Tools,” etc., may also provide different function options under different operation modes for different users. For example, under the simple mode 110, the function menu “PhoneBook” may only provide common options such as “New,” “Delete” and “Edit.” Under the advanced mode 120, the function menu “PhoneBook” may further provide advanced options such as “Sorting” and “Grouping” for users to arrange contact items. Under the engineering mode 130, the function menu “PhoneBook” may provide some options for users to do basic settings of the “PhoneBook,” such as setting icons of the “PhoneBook,” setting character colors, character fonts, character size of the contact items in the “PhoneBook.”

It may be understood that the different operation modes (e.g., simple mode, advanced mode, engineering mode) may be applied and varied from application to application and may be used as a system wide preference. That is, all applications may use the same user-selected mode, while individual applications may use either a simple mode or an advanced mode, for example. Accordingly, different users having different requirements may use the electronic device 10 and use the different operation modes according to their requirements.

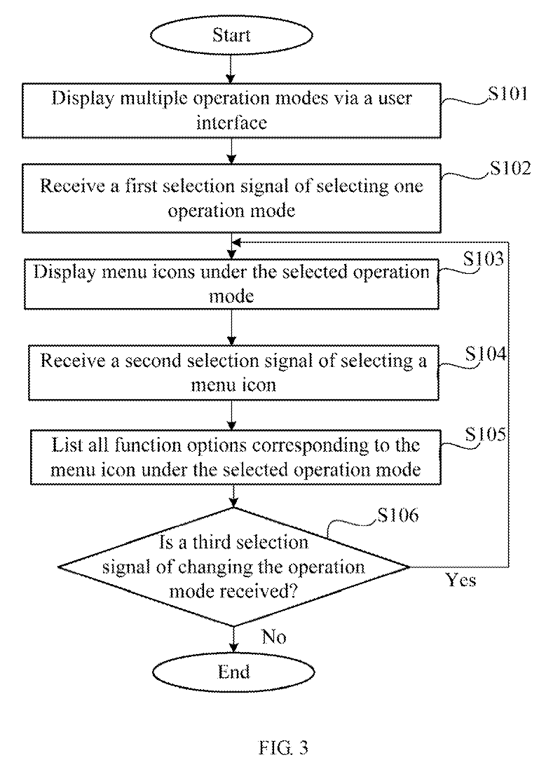

FIG. 3 is a flowchart of one embodiment of a method of providing multiple operation modes in the electronic device 10. Depending on the embodiment, additional blocks may be added, others removed, and the ordering of the blocks may be changed.

In block S101, when the electronic device 10 is powered on, the user interface 100 displays icons of multiple operation modes. In one embodiment, the operation modes may include a simple mode 110, an advanced mode 120, and an engineering mode 130. The electronic device 10 may provide different function options in different operation modes. Depending on this embodiment, the electronic device 10 may be a mobile telephone.

In block S102, the user interface 100 receive a first selection signal of selecting one operation mode, e.g. the common mode 110, from a user via an input device. The input device may be a keyboard or a touch screen, for example.

In block S103, the user interface 100 displays menu icons under the selected operation mode. For example, in the common mode 110, the menu icons may only include icons of “Messages,” “PhoneBook,” “Ring Styles” and “Recent Calls.” In the advance mode 120 and the engineering mode 130, the menu icons may further include icons of “My Favorites,” “Tools,” “Settings,” “China Mobile in,” “Customer Service,” and so on.

In block S104, the user interface 100 receives a second selection signal of selecting a menu icon, such as the “PhoneBook” icon, from the input device.

In block S105, the user interface 100 displays function options corresponding to the selected menu icon under the selected operation mode. For example, under the simple mode 110, the function options corresponding to the menu “PhoneBook” may only include “New,” “Delete” and “Edit.” Under the advanced mode 120, the function options corresponding to the menu “PhoneBook” may further include “Sorting” and “Grouping” for user to arrange contact items. Under the engineering mode 130, the function options corresponding to the menu “PhoneBook” may further include some basic setting options for users to do basic settings of the “PhoneBook,” such as setting icons of the “PhoneBook,” setting character colors, character fonts, character size of the contact items in the “PhoneBook.”

In block S106, the user interface 100 monitors if a third selection signal of changing the selected operation mode is received from the input device. If the user interface 100 receives a third select signal of changing the selected operation mode, such as a touch signal of selecting the icon of the advanced mode 120, the procedure returns back to S103 as described above. A user can also touch the “Back” icon to come back to the last directory to see icons of all the operation modes and select a favorite operation mode.

The above embodiments provide multiple operation modes in the electronic device 10, these operation modes can provide different complex degrees of function options, so as to satisfy users with different demands of the electronic device 10. The users can also flexibly change the electronic device 10 from one operation mode to another operation mode.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device having multiple operation modes comprising:
a memory system;
at least one processor; and
one or more programs, wherein the one or more programs are stored in the memory system and configured to be executed by the at least one processor, the one or more programs comprising:
a user interface displayed via a display device connected to the electronic device, wherein the user interface displays icons corresponding to the multiple operation modes, receives a selection signal corresponding to a user-selected operation mode from an input device, and provides and displays corresponding function options to the user interface under the user-selected operation mode.

2. The electronic device as claimed in claim 1, wherein the multiple operation modes provide different functions to the user interface corresponding to each of the multiple operation modes, wherein the different functions correspond to different degrees of complexity.

3. The electronic device as claimed in claim 1, wherein the electronic device is a mobile phone.

4. The electronic device as claimed in claim 1, wherein the input device is a keyboard or a touch screen.

5. The electronic device as claimed in claim 1, wherein the memory system is selected from the group consisting of a smart media card, a secure digital card, and a compact flash card.

6. The electronic device as claimed in claim 1, wherein the multiple operation modes are selected from the group consisting of a simple mode, an advanced mode, and an engineering mode.

7. A method of providing multiple operation modes in an electronic device, the method comprising:
displaying icons corresponding to the multiple operation modes, wherein the icons are displayed on a user interface of a display of the electronic device;
receiving a first selection signal of selecting one operation mode from the multiple operation modes from an input device;
displaying menu icons under the selected operation mode;
receiving a second selection signal of selecting a menu icon from the displayed menu icons, from the input device;
displaying function options corresponding to the selected menu icon under the selected operation mode; and
monitoring if a third selection signal of changing the selected operation mode is received from the input device, and in response to receiving the third selection signal, displaying menu icons of a newly selected operation mode.

8. The method as claimed in claim 7, wherein the multiple operation modes provide different functions to the user interface corresponding to each of the multiple operation modes, wherein the different functions correspond to different degrees of complexity.

9. The method as claimed in claim 7, wherein the electronic device is a mobile phone.

10. The method as claimed in claim 7, wherein the input device is a keyboard or a touch screen.

11. The method as claimed in claim 7, wherein the memory system is selected from the group consisting of a smart media card, a secure digital card, and a compact flash card.

12. The method as claimed in claim 7, wherein the multiple operation modes are selected from the group consisting of a simple mode, an advanced mode, and an engineering mode.

13. A storage medium having stored thereon instructions that, when executed by an electronic device, causing the electronic device to provide multiple operation modes, wherein the electronic device has a user interface displayed via a display device connected to the electronic device, wherein the user interface displays icons corresponding to the multiple operation modes, receives a selection signal corresponding to a user-selected operation mode from an input device, and provides and displays corresponding function options to the user interface under the user-selected operation mode.

14. The storage medium as claimed in claim 13, wherein the multiple operation modes provide different functions to the user interface corresponding to each of the multiple operation modes, wherein the different functions correspond to different degrees of complexity.

15. The storage medium as claimed in claim 13, wherein the electronic device is a mobile phone.

16. The storage medium as claimed in claim 13, wherein the input device is a keyboard or a touch screen.

17. The storage medium as claimed in claim 13, wherein the storage medium is selected from the group consisting of a smart media card, a secure digital card, and a compact flash card.

18. The storage medium as claimed in claim 13, wherein the multiple operation modes are selected from the group consisting of a simple mode, an advanced mode, and an engineering mode.
